(19) United States
(12) Patent Application Publication
(10) Pub. No.: US 2020/0282977 A1
(43) Pub. Date: Sep. 10, 2020

(54) VEHICLE CONTROL DEVICE, VEHICLE CONTROL SYSTEM, VEHICLE CONTROL METHOD, AND STORAGE MEDIUM

(71) Applicant: HONDA MOTOR CO., LTD., Minato-ku (JP)

(72) Inventors: Yuki Hara, Wako-shi (JP); Yasushi Shoda, Wako-shi (JP); Junpei Noguchi, Wako-shi (JP); Ryoma Taguchi, Tokyo (JP); Yuta Takada, Tokyo (JP)

(21) Appl. No.: 16/804,011

(22) Filed: Feb. 28, 2020

(30) Foreign Application Priority Data
Mar. 7, 2019 (JP) 2019-041634

(51) Int. Cl. B60W 30/06; B60W 50/14; B60W 60/00

(52) U.S. Cl. CPC B60W 30/06; G06K 9/00812; B60W 60/0023; B60W 50/14

(57) ABSTRACT

A vehicle control device includes: a recognizer configured to recognize a surrounding environment of a vehicle; a driving controller configured to perform driving control including at least one of speed control and steering control of the vehicle on the basis of a result of recognition from the recognizer; and an information acquirer configured to acquire surrounding environment information of the surrounding environment of the vehicle in a predetermined space on the basis of the result of recognition from the recognizer in a period after the vehicle enters the predetermined space and before the vehicle exits the predetermined space under the driving control of the driving controller, and to upload the acquired surrounding environment information to an external device.

### CROSS-REFERENCE TO RELATED APPLICATION

Priority is claimed on Japanese Patent Application No. 2019-041634, filed Mar. 7, 2019, the content of which is incorporated herein by reference.

### BACKGROUND

### Field of the Invention

The invention relates to a vehicle control device, a vehicle control system, a vehicle control method, and a storage medium.

### Description of Related Art

Recently, automatic control of a vehicle has been studied. A valet parking system that automatically moves a vehicle based on results of such a study is known (Published Japanese Translation No. 2017-526569 of the PCT International Publication).

### SUMMARY

However, the valet parking system according to the related art is based on the premise of implementation in a dedicated parking lot employing the system, and implementation in an existing parking lot in which a map in the parking lot is not known is not supposed. Accordingly, study for implementation of a valet parking system that automatically moves a vehicle in an existing parking lot has not been satisfactorily carried out.

An aspect of the invention is made in consideration of the above-mentioned circumstances and an objective thereof is to provide a vehicle control device, a vehicle control system, a vehicle control method, and a storage medium that can contribute to expansion of parking lots to which a valet parking system that automatically moves a vehicle can be applied.

A vehicle control device, a vehicle control system, a vehicle control method, and a storage medium according to the invention employ the following configurations.

(1): According to an aspect of the invention, there is provided a vehicle control device including: a recognizer configured to recognize a surrounding environment of a vehicle; a driving controller configured to perform driving control including at least one of speed control and steering control of the vehicle on the basis of a result of recognition from the recognizer; and an information acquirer configured to acquire surrounding environment information of the surrounding environment of the vehicle in a predetermined space on the basis of the result of recognition from the recognizer in a period after the vehicle enters the predetermined space and before the vehicle exits the predetermined space under the driving control of the driving controller, and to upload the acquired surrounding environment information to an external device.

(2) In the aspect of (1), the information acquirer may be configured to acquire the surrounding environment information when the driving controller performs the driving control in the period.

(3) In the aspect of (1), the driving controller may be configured to perform the driving control for acquiring the surrounding environment information when a predetermined condition has been satisfied.

(4) In the aspect of (3), the predetermined condition may include a condition that the predetermined space is a parking lot in which map information has not been registered in the external device.

(5) In the aspect of (3), the predetermined condition may include a condition that uploading of the surrounding environment information is permitted by a user of the vehicle.

(6) In the aspect of (3), the driving controller may be configured to perform driving control for acquiring the surrounding environment information in a limited range when a travel distance by which the vehicle travels to acquire the surrounding environment information is limited by a user of the vehicle.

(7) In the aspect of (3), the driving controller may be configured to perform driving control for acquiring the surrounding environment information in a limited range when the number of times the vehicle is parked to acquire the surrounding environment information is limited by a user of the vehicle.

(8) In the aspect of (3), the driving controller may be configured to derive a travelable distance on the basis of an amount of residual energy of the vehicle, to select the shorter of the derived travelable distance and a travel distance which is limited by a user of the vehicle, and to perform driving control for acquiring the surrounding environment information in a range of the selected distance.

(9) In the aspect of (3), the vehicle control device may further include a congestion situation determiner configured to determine whether the predetermined space is congested, and the predetermined condition may include a condition that the congestion situation determiner determines that the predetermined space is not congested.

(10) In the aspect of (1), the predetermined space may be a parking lot, and the period may be a period after the vehicle enters the parking lot and before the vehicle exits the parking lot.

(11) In the aspect of (1), the information acquirer may be configured to acquire the surrounding environment information on the basis of the result of recognition from the recognizer when the vehicle is traveling without a driver in the predetermined space.

(12) According to an aspect of the invention, there is provided a vehicle control system including: the vehicle control device according to the aspect of (1); and the external device including a point manager configured to determine points which are provided to a user of the vehicle having uploaded the surrounding environment information on the basis of the surrounding environment information acquired by the information acquirer. The point manager is configured to determine the points on the basis of the surrounding environment information which is obtained by excluding information acquired in travel for parking at a closest parking space or the parking from information acquired in a period after the vehicle has entered the predetermined space and before the vehicle has exited from the predetermined space.

(13) In the aspect of (12), the point manager may be configured to determine the points which vary depending on an amount of information of the surrounding environment information or a time point at which the surrounding environment information has been acquired.

(14) In the aspect of (12), the point manager may be configured to set the points which are provided to a user of the vehicle to be higher when the user presents an intention to agree to travel of the vehicle to acquire the surrounding environment information than when the user does not present the intention to agree.

(15) According to an aspect of the invention, there is provided a vehicle control method of causing a computer mounted in a vehicle to perform: recognizing a surrounding environment of the vehicle; performing driving control including at least one of speed control and steering control of the vehicle on the basis of a result of recognition; acquiring surrounding environment information of the surrounding environment of the vehicle in a predetermined space on the basis of the result of recognition from the recognizer in a period after the vehicle enters the predetermined space and before the vehicle exits the predetermined space under the driving control; and uploading the acquired surrounding environment information to an external device.

(16) According to an aspect of the invention, there is provided a non-transitory computer-readable storage medium that stores a program causing a computer mounted in a vehicle to perform: recognizing a surrounding environment of the vehicle; performing driving control including at least one of speed control and steering control of the vehicle on the basis of a result of recognition; acquiring surrounding environment information of the surrounding environment of the vehicle in a predetermined space on the basis of the result of recognition from the recognizer in a period after the vehicle enters the predetermined space and before the vehicle exits the predetermined space under the driving control; and uploading the acquired surrounding environment information to an external device.

According to the aspects of (1) to (16), it is possible to contribute to expansion of parking lots to which a valet parking system that automatically moves a vehicle can be applied.

### BRIEF DESCRIPTION OF THE DRAWINGS

FIG. 1 is a diagram illustrating a configuration of a vehicle system employing a vehicle control device according to an embodiment;

FIG. 2 is a diagram illustrating functional configurations of a first controller and a second controller;

FIG. 3 is a diagram schematically illustrating a scenario in which an automatic parking event is performed;

FIG. 4 is a diagram illustrating an example of a configuration of a parking lot management device;

FIG. 5 is a diagram illustrating an example of a configuration of a map server;

FIG. 6 is a diagram illustrating an example of a second route;

FIG. 7 is a diagram illustrating an example of a second route;

FIG. 8 is a diagram illustrating an example of a second parking space;

FIG. 9 is a diagram illustrating an example of a second parking space;

FIG. 10 is a flowchart illustrating an example of a process flow which is performed by an automatic parking controller and a surrounding environment information acquirer;

FIG. 11 is a flowchart illustrating another example of a process flow which is performed by the automatic parking controller and the surrounding environment information acquirer; and

FIG. 12 is a diagram illustrating an example of a hardware configuration of an automated driving control device according to an embodiment.

### DESCRIPTION OF EMBODIMENTS

Hereinafter, a vehicle control device, a vehicle control system, a vehicle control method, and a storage medium according to an embodiment of the invention will be described with reference to the accompanying drawings.

Entire Configuration

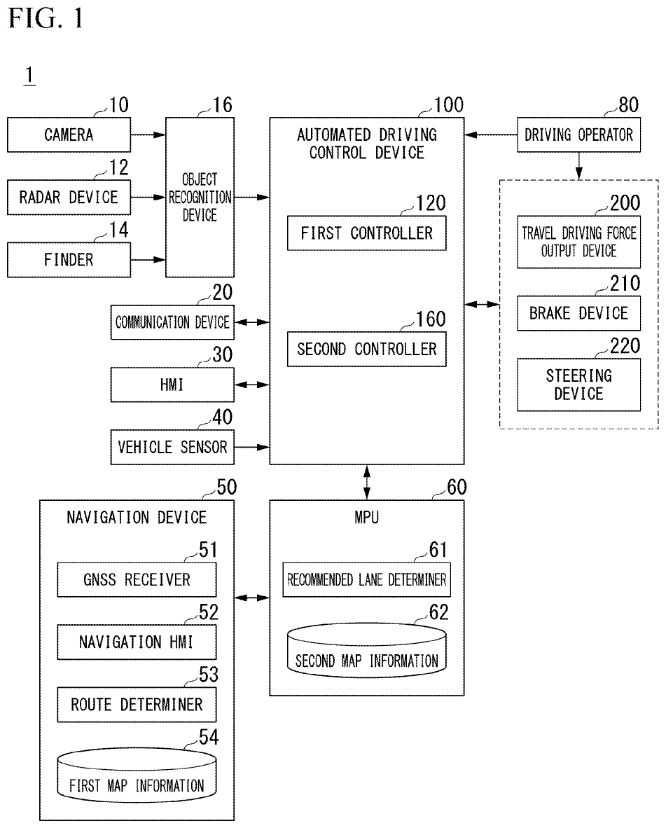

FIG. 1 is a diagram illustrating a configuration of a vehicle system 1 to which a vehicle control device according to an embodiment is applied. A vehicle in which the vehicle system 1 is mounted is, for example, a vehicle with two wheels, three wheels, or four wheels and a drive source thereof is an internal combustion engine such as a diesel engine or a gasoline engine, an electric motor, or a combination thereof. An electric motor operates using electric power which is generated by a power generator connected to the internal combustion engine or electric power which is discharged from a secondary battery or a fuel cell.

The vehicle system 1 includes, for example, a camera 10, a radar device 12, a finder 14, an object recognition device 16, a communication device 20, a human-machine interface (HMI) 30, a vehicle sensor 40, a navigation device 50, a map positioning unit (MPU) 60, a driving operator 80, an automated driving control device 100, a travel driving force output device 200, a brake device 210, and a steering device 220. These devices or instruments are connected to each other via a multiplex communication line such as a controller area network (CAN) communication line, a serial communication line, a radio communication network, or the like. The configuration illustrated in FIG. 1 is only an example and a part of the configuration may be omitted or another configuration may be added thereto.

The camera 10 is, for example, a digital camera using a solid-state imaging device such as a charge coupled device (CCD) or a complementary metal oxide semiconductor (CMOS). The camera 10 is attached to an arbitrary position on a vehicle (hereinafter referred to as a host vehicle M) in which the vehicle system 1 is mounted. For example, when the front of the host vehicle M is imaged, the camera 10 is attached to an upper part of a front windshield, a rear surface of a rearview mirror, or the like. The camera 10 images surroundings of the host vehicle M, for example, periodically and repeatedly. The camera 10 may be a stereoscopic camera.

The radar device 12 radiates radio waves such as millimeter waves to the surroundings of the host vehicle M, detects radio waves (reflected waves) reflected by an object, and detects at least a position (a distance and a direction) of the object. The radar device 12 is attached to an arbitrary position on the host vehicle M. The radar device 12 may detect a position and a speed of an object using a frequency modulated continuous wave (FM-CW) method.

The finder 14 is a Light Detection And Ranging device (LIDAR). The finder 14 applies light to the surroundings of the host vehicle M and measures scattered light. The finder 14 detects a distance to an object on the basis of a time from emission of light to reception of light. The light which is applied is, for example, a pulse-like laser beam. The finder 14 is attached to an arbitrary position on the host vehicle M.

The object recognition device 16 performs a sensor fusion process on results of detection from some or all of the camera 10, the radar device 12, and the finder 14 and recognizes a position, a type, a speed, and the like of an object. The object recognition device 16 outputs the result of recognition to the automated driving control device 100.

The object recognition device 16 may output the results of detection from the camera 10, the radar device 12, and the finder 14 to the automated driving control device 100 without any change. The object recognition device 16 may be omitted from the vehicle system 1.

The communication device 20 communicates with another vehicle near the host vehicle M, a parking lot management device (which will be described later), or various server devices, for example, using a cellular network, a Wi-Fi network, Bluetooth (registered trademark), or dedicated short range communication (DSRC).

The HMI 30 presents various types of information to an occupant of the host vehicle M and receives an input operation from the occupant. The HMI 30 includes various display devices, speakers, buzzers, touch panels, switches, and keys.

The vehicle sensor 40 includes a vehicle speed sensor that detects a speed of the host vehicle M, an acceleration sensor that detects acceleration, a yaw rate sensor that detects an angular velocity around a vertical axis, and a direction sensor that detects a direction of the host vehicle M.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of the host vehicle M on the basis of signals received from GNSS satellites. The position of the host vehicle M may be identified or complemented by an inertial navigation system (INS) using the output of the vehicle sensor 40. The navigation HMI 52 includes a display device, a speaker, a touch panel, and keys. All or a part of the navigation HMI 52 may be shared by the HMI 30. For example, the route determiner 53 determines a route (hereinafter a route on a map) from the position of the host vehicle M identified by the GNSS receiver 51 (or an input arbitrary position) to a destination input by an occupant using the navigation HMI 52 with reference to the first map information 54. The first map information 54 is, for example, information in which road shapes are expressed by links indicating roads and nodes connected by the links. The first map information 54 may include a curvature of a road or point of interest (POI) information. The route on a map is output to the MPU 60. The navigation device 50 may perform guidance for a route using the navigation HMI 52 on the basis of the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and may acquire a route which is equivalent to the route on a map from the navigation server.

The MPU 60 includes, for example, a recommended lane determiner 61 and stores second map information 62 in a storage device such as an HDD or a flash memory. The recommended lane determiner 61 divides the route on a map supplied from the navigation device 50 into a plurality of blocks (for example, every 100 [m] in a vehicle traveling direction) and determines a recommended lane for each block with reference to the second map information 62. The recommended lane determiner 61 determines on which lane from the leftmost the vehicle will travel. When there is a branching point in the route on a map, the recommended lane determiner 61 determines a recommended lane such that the host vehicle M travels on a rational route for traveling to a branching destination.

The second map information 62 is map information with higher precision than the first map information 54. The second map information 62 includes, for example, information of the center of a lane or information of boundaries of a lane. The second map information 62 may include road information, traffic regulation information, address information (addresses and postal codes), facility information, and phone number information. The second map information 62 may be updated from time to time by communicating with another device using the communication device 20.

The driving operator 80 includes, for example, an accelerator pedal, a brake pedal, a shift lever, a steering wheel, a deformed steering, a joystick, and other operators. A sensor that detects an amount of operation or performing of an operation is attached to the driving operator 80, and results of detection thereof are output to some or all of the automated driving control device 100, the travel driving force output device 200, the brake device 210, and the steering device 220.

The automated driving control device 100 includes, for example, a first controller 120 and a second controller 160. The first controller 120 and the second controller 160 are realized, for example, by causing a hardware processor such as a central processing unit (CPU) to execute a program (software). Some or all of such elements may be realized in hardware (which includes circuitry) such as a large scale integration (LSI), an application specific integrated circuit (ASIC), or a field-programmable gate array (FPGA), or a graphics processing unit (GPU) or may be realized in cooperation of software and hardware. The program may be stored in a storage device such as an HDD or a flash memory of the automated driving control device 100 (a storage device including a non-transitory storage medium) in advance, or may be installed in the HDD or the flash memory of the automated driving control device 100 by storing the program in a detachable storage medium (the non-transitory storage medium) such as a DVD or a CD-ROM and attaching the storage medium to the HDD or the flash memory of the automated driving control device 100.

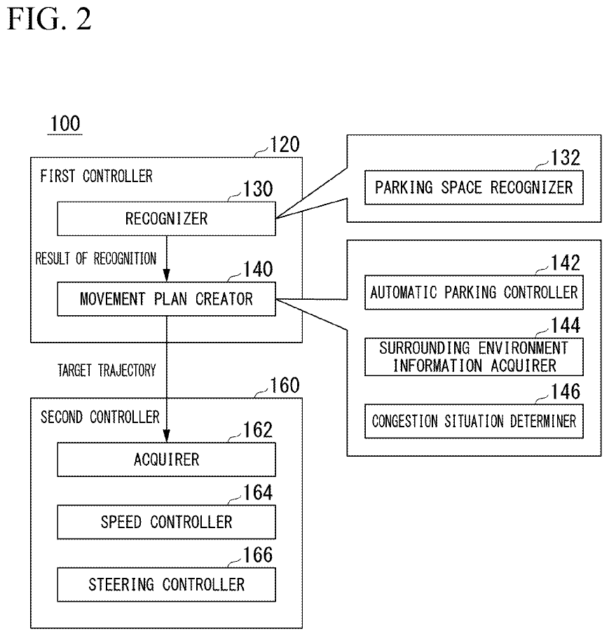

FIG. 2 is a diagram illustrating functional configurations of the first controller 120 and the second controller 160. The first controller 120 includes, for example, a recognizer 130 and a movement plan creator 140. The first controller 120 realizes, for example, an artificial intelligence (AI) function and a function based on a predetermined model together. For example, a function of “recognizing a crossing” may be embodied by performing recognition of a crossing based on deep learning or the like and recognition based on predetermined conditions (such as signals which can be pattern-matched and road signs), scoring both recognitions, and comprehensively evaluating both recognitions. Accordingly, reliability of automated driving is secured.

The recognizer 130 recognizes states of a position, a speed, and acceleration of an object near the host vehicle M, for example, on the basis of information input from the camera 10, the radar device 12, and the finder 14 via the object recognition device 16. For example, a position of an object is recognized, for example, as a position in an absolute coordinate system with an origin set to a representative point of the host vehicle M (such as the center of gravity or the center of a drive shaft) and is used for control. A position of an object may be expressed as a representative point such as the center of gravity or a corner of the object or may be expressed as a drawn area. A “state” of an object may include an acceleration or a jerk of the object or a “moving state” (for example, whether lane change is being performed or whether lane change is going to be performed) thereof.

The recognizer 130 recognizes, for example, a lane (a traveling lane) on which the host vehicle M is traveling. For example, the recognizer 130 recognizes the traveling lane by comparing a pattern of road markings near the host vehicle M which are recognized from an image captured by the camera 10 with a pattern of road markings (for example, arrangement of a solid line and a dotted line) which are acquired from the second map information 62. The recognizer 130 is not limited to road markings, but may recognize the traveling lane by recognizing a traveling road boundary (a road boundary) including road markings, edges of a roadside, a curbstone, a median, and a guard rail. In this recognition, the position of the host vehicle M acquired from the navigation device 50 and the result of processing from the INS may be considered. The recognizer 130 recognizes a stop line, an obstacle, a red signal, a toll gate, or other road events.

The recognizer 130 recognizes a position or a direction of the host vehicle M with respect to a traveling lane at the time of recognition of the traveling lane. The recognizer 130 may recognize, for example, separation of a reference point of the host vehicle M from the lane center and an angle of the traveling direction of the host vehicle M with respect to a line formed by connecting the lane centers as the position and the direction of the host vehicle M relative to the traveling lane. Instead, the recognizer 130 may recognize a position of the reference point of the host vehicle M relative to one side line of the traveling lane (a road marking or a road boundary) or the like as the position of the host vehicle M relative to the traveling lane.

The recognizer 130 includes a parking space recognizer 132 that is started in an automatic parking event which will be described later. Details of the function of the parking space recognizer 132 will be described later.

The movement plan creator 140 generates a target trajectory in which the host vehicle M will travel automatically (without requiring a driver's operation or the like) in the future such that the host vehicle M travels on a recommended lane determined by the recommended lane determiner 61 in principle and copes with surrounding circumstances of the host vehicle M. A target trajectory includes, for example, a speed element. For example, a target trajectory is expressed by sequentially arranging points (path points) at which the host vehicle M will arrive. The path points are points at which the host vehicle M is to arrive at intervals of a predetermined traveling distance (for example, about several [n]) along a road, and a target speed and a target acceleration at intervals of a predetermined sampling time (for example, about below the decimal point [sec]) are generated as a part of a target trajectory in addition. Path points may be positions at which the host vehicle M is to arrive at sampling times every predetermined sampling time. In this case, information of a target speed or target acceleration is expressed by intervals between the path points.

The movement plan creator 140 may set events of automated driving in generating a target trajectory. The events of automated driving include a constant-speed travel event, a low-speed following travel event, a lane change event, a branching event, a merging event, a takeover event, and an automatic parking event in which the host vehicle M travels and parks without a driver in valet parking or the like. The movement plan creator 140 generates a target trajectory based on events which are started. The movement plan creator 140 includes an automatic parking controller 142, a surrounding environment information acquirer 144, and a congestion situation determiner 146 which are started when the automatic parking event is performed. The details of the functions of the automatic parking controller 142, the surrounding environment information acquirer 144, and the congestion situation determiner 146 will be described later.

The second controller 160 controls the travel driving force output device 200, the brake device 210, and the steering device 220 such that the host vehicle M passes along the target trajectory generated by the movement plan creator 140 as scheduled.

Referring back to FIG. 2, the second controller 160 includes, for example, an acquirer 162, a speed controller 164, and a steering controller 166. The acquirer 162 acquires information of a target trajectory (path points) generated by the movement plan creator 140 and stores the generated information in a memory (not illustrated). The speed controller 164 controls the travel driving force output device 200 or the brake device 210 on the basis of a speed element pertained to the target trajectory stored in the memory. The steering controller 166 controls the steering device 220 on the basis of a curved state of the target trajectory stored in the memory. The processes of the speed controller 164 and the steering controller 166 are embodied, for example, in a combination of feed-forward control and feedback control. For example, the steering controller 166 performs feed-forward control based on a curvature of a road in front of the host vehicle M and feedback control based on separation from the target trajectory in combination.

The travel driving force output device 200 outputs a travel driving force (a torque) for allowing a vehicle to travel to driving wheels. The travel driving force output device 200 includes, for example, a combination of an internal combustion engine, an electric motor, and a transmission and an electronic controller (ECU) that controls them. The ECU controls the above-mentioned configuration on the basis of information input from the second controller 160 or information input from the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the second controller 160 or the information input from the driving operator 80 such that a brake torque based on a braking operation is output to vehicle wheels. The brake device 210 may include a mechanism for transmitting a hydraulic pressure generated by an operation of a brake pedal included in the driving operator 80 to the cylinder via a master cylinder as a backup. The brake device 210 is not limited to the above-mentioned configuration, and may be an electronically controlled hydraulic brake device that controls an actuator on the basis of information input from the second controller 160 such that the hydraulic pressure of the master cylinder is transmitted to the cylinder.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the second controller 160 or the information input from the driving operator 80 to change the direction of the turning wheels.

Automatic Parking Event—Entrance

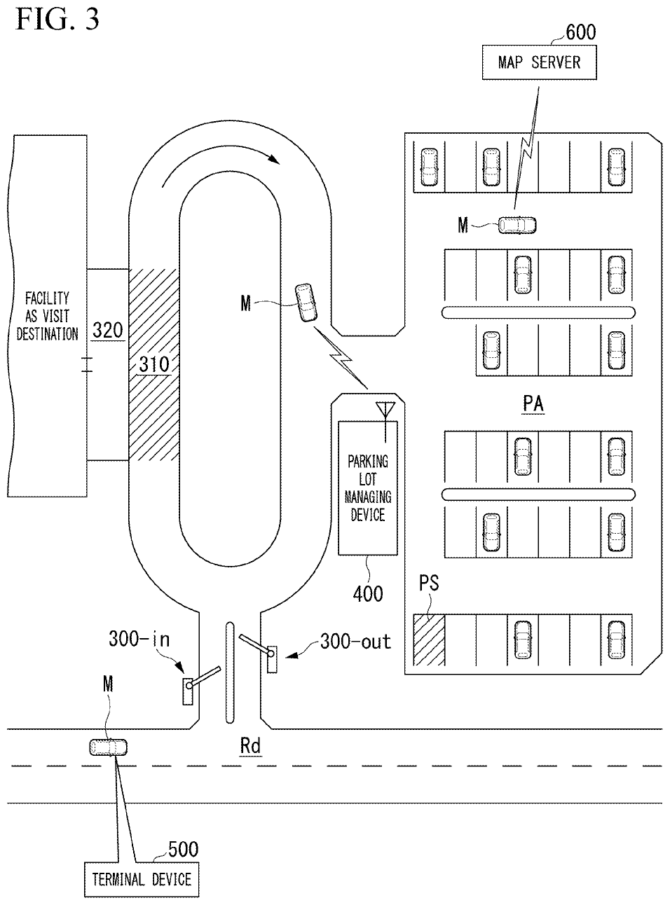

The automatic parking controller 142 causes the host vehicle M to park in a parking space on the basis of information acquired from a parking lot management device 400 via the communication device 20. FIG. 3 is a diagram schematically illustrating a scenario in which the automatic parking event is performed. Gates 300-in and 300-out are provided on a route from a road Rd to a facility that is a visit destination. The host vehicle M passes through the gate 300-in and travels to a stop area 310 by manual driving or automated driving. The stop area 310 is located in the vicinity of a boarding/alighting area 320 which is connected to the facility that is a visit destination. An awning for blocking snow or rain is provided in the boarding/alighting area 320.

The host vehicle M starts an automatic parking event of performing automated driving without a driver and moving to a target parking space PS (hereinafter referred to as a first parking space PS1) in a parking lot PA after an occupant has alighted in the stop area 310. The first parking space PS1 is, for example, a parking space to which a moving distance of the host vehicle M is the shortest out of empty parking spaces in the parking lot PA. A trigger for starting the automatic parking event may be, for example, a certain operation of an occupant or may be reception of a predetermined signal from the parking lot management device 400 by radio communication. The certain operation of an occupant may be input using the HMI 30 or may be input using a terminal device 500 of an occupant which communicates with the communication device 20. When the automatic parking event is started, the automatic parking controller 142 controls the communication device 20 such that a parking request is transmitted to the parking lot management device 400. Then, the host vehicle M moves from the stop area 310 to the parking lot PA while sensing the surrounding environment according to guidance of the parking lot management device 400 or autonomously.

When the automatic parking event is started, the surrounding environment information acquirer 144 acquires information on the surrounding environment (hereinafter referred to as surrounding environment information) of the host vehicle M on the basis of the result of recognition which is recognized by the recognizer 130 in a period after the host vehicle M has entered the parking lot PA and before the host vehicle M exits the parking lot PA (hereinafter referred to as a valet parking period). The surrounding environment information includes, for example, a distance between the host vehicle M and an object (such as a wall), a position of a post in the parking lot, and an area of the parking space. The parking lot PA is an example of a predetermined space. The surrounding environment information acquirer 144 is not limited to the above-mentioned example, and it may acquire surrounding environment information on the basis of the result of recognition recognized by the recognizer 130 in the period after the host vehicle M has entered the predetermined space and before the host vehicle exits the predetermined space. The predetermined space is not limited to a space including a parking space, and may be a space including a public road or a private road or may be a part of private land. The predetermined space may be an internal space of a building or an external space such as an outdoor space.

The surrounding environment information acquirer 144 may acquire surrounding environment information on the basis of a traveling distance or a traveling direction of the host vehicle M in the valet parking period. Information indicating the traveling distance or the traveling direction or the like of the host vehicle M is, for example, information based on a result of detection from a detection unit (not illustrated) that detects a distance that the host vehicle M has actually traveled such as a result of detection from the vehicle sensor 40 or a target trajectory which is generated by the automatic parking controller 142.

The automatic parking controller 142 or the surrounding environment information acquirer 144 determines whether a driver is in the host vehicle M when the host vehicle M enters the parking lot PA on the basis of the result of detection from a sensor which is mounted in the host vehicle, and may acquire the surrounding environment information when the host vehicle M enters the parking lot PA without a driver. The sensor which is mounted in the vehicle includes a seat sensor that is attached to a seat, a sensor that detects movement in the vehicle, and a camera. The invention is not limited thereto, and when valet parking is instructed by a user, the automatic parking controller 142 or the surrounding environment information acquirer 144 of the automated driving control device 100 may cause the host vehicle M to enter the parking lot PA without a driver. An example in which the surrounding environment information acquirer 144 acquires surrounding environment information on the basis of the result of recognition recognized by the recognizer 130 while the host vehicle M is traveling in the parking lot PA without a driver will be described below. In this case, since the host vehicle M can travel without a driver and acquire surrounding environment information, it is possible to acquire surrounding environment information while curbing an influence on behavior of a user of the host vehicle M. The invention is not limited thereto, and the surrounding environment information acquirer 144 may acquire surrounding environment information while the host vehicle M travels with an occupant therein.

The surrounding environment information acquirer 144 of the host vehicle M uploads the acquired surrounding environment information to a map server 600 using the communication device 20. In the following description, the surrounding environment information acquirer 144 uploads the acquired surrounding environment information to the map server 600, but the invention is not limited thereto. For example, the surrounding environment information acquirer 144 may upload the acquired surrounding environment information to the parking lot management device 400 and the parking lot management device 400 may generate map information of the parking lot on the basis of the acquired surrounding environment information.

The congestion situation determiner 146 determines a congestion situation of a predetermined space (for example, a parking lot PA). For example, when the number of vehicles in the parking lot PA which is received from the parking lot management device 400 via the communication device 20 is equal to or greater than a first threshold value, the congestion situation determiner 146 determines that the parking lot PA is congested. The parking lot management device 400 derives the number of vehicles in the parking lot PA, for example, by subtracting the number of vehicles exiting the parking lot PA from the number of vehicles entering the parking lot PA. Other vehicles in the parking lot PA include, for example, other vehicles parked in the parking a lot PA and other vehicles traveling in the parking lot PA.

The invention is not limited thereto, and when a ratio of the number of vehicles in the parking lot PA to a predetermined number of vehicles which can be accommodated in the parking lot PA is equal to or greater than a second threshold value, the congestion situation determiner 146 may determine that the parking lot PA is congested. When the number of other vehicles traveling before and after the host vehicle M is equal to or greater than a third threshold value on the basis of the result of recognition from the recognizer 130, the congestion situation determiner 146 may determine that the parking a lot PA is congested. This process which is performed by the congestion situation determiner 146 may be performed by the parking lot management device 400 and a result of determination indicating whether the parking lot PA is congested may be transmitted to the host vehicle M.

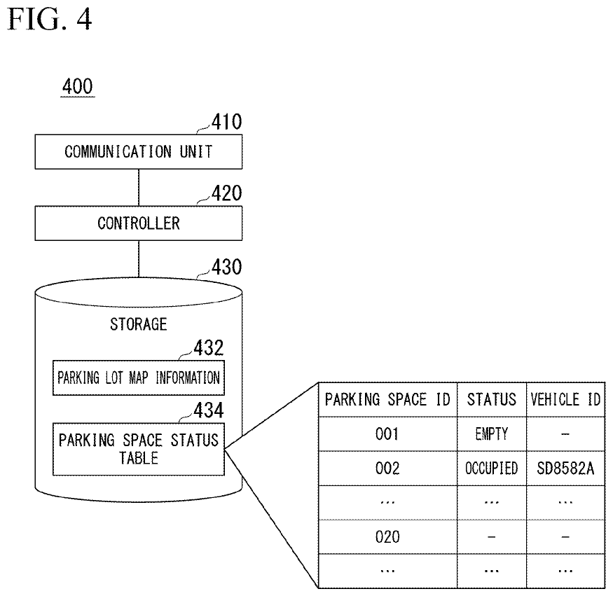

FIG. 4 is a diagram illustrating an example of the configuration of the parking lot management device 400. The parking lot management device 400 includes, for example, a communication unit 410, a controller 420, and a storage 430. Information such as parking lot map information 432 and a parking space status table 434 is stored in the storage 430.

The communication unit 410 communicates with the host vehicle M or other vehicles wirelessly. The controller 420 guides a vehicle to a parking space PS on the basis of information acquired by the communication unit 410 and information stored in the storage 430. The parking lot map information 432 is information geometrically representing the structure of the parking lot PA (a general drawing indicating routes or sizes or positions of parking spaces PS) (hereinafter referred to as map information). The parking lot map information 432 includes coordinates of each parking space PS and size information for each parking space PS which are correlated with map information. The size information for each parking space PS may be reflected in map information geometrically indicating the structure of the parking a lot PA. In the parking space status table 434, for example, a parking space ID which is identification information of a parking space PS is correlated with information indicating whether the parking space is empty or full (parked) and a vehicle ID which is identification information of a vehicle parked in the parking space.

When the communication unit 410 receives a parking request from a vehicle, the controller 420 extracts a parking space PS of which the status is an empty status with reference to the parking space status table 434, acquires the position of the extracted parking space PS from the parking lot map information 432, and transmits a suitable route to the acquired position of the parking space PS to the vehicle via the communication unit 410. The controller 420 instructs specific vehicles to stop or move slowly if necessary such that vehicles do not enter the same position at the same time on the basis of positional relationships between a plurality of vehicles.

In a vehicle having received a route (hereinafter referred to as a host vehicle M), the automatic parking controller 142 generates a target trajectory based on the route. When the first parking space PS1 which is a target is approached, the parking space recognizer 132 recognizes a parking frame line defining the first parking space PS1 or the like, recognizes a detailed position of the first parking space PS1, and provides the recognized detailed position to the automatic parking controller 142. The automatic parking controller 142 receives the detailed position, corrects the target trajectory, and causes the host vehicle M to be parked in the first parking space PS1.

Automatic Parking Event—Exit

The automatic parking controller 142 and the communication device 20 keep operating even when the host vehicle M is parked. For example, when the communication device 20 receives a pickup request from the terminal device 500 of an occupant, the automatic parking controller 142 starts a system of the host vehicle M and moves the host vehicle to the stop area 310. At this time, the automatic parking controller 142 controls the communication device 20 such that a departure request is transmitted to the parking lot management device 400. Similarly to entrance, the controller 420 of the parking lot management device 400 instructs specific vehicles to stop or move slowly if necessary such that vehicles do not enter the same position at the same time on the basis of positional relationships between a plurality of vehicles. When the host vehicle M is moved to the stop area 310 and an occupant boards the host vehicle M, the automatic parking controller 142 stops its operation and then manual driving or automated driving using other functional units is started.

The invention is not limited to the above description, and the automatic parking controller 142 may not depend on communication but may search for an empty parking space on the basis of the results of detection from the camera 10, the radar device 12, the finder 14, or the object recognition device 16 and park the host vehicle M in the searched parking space.

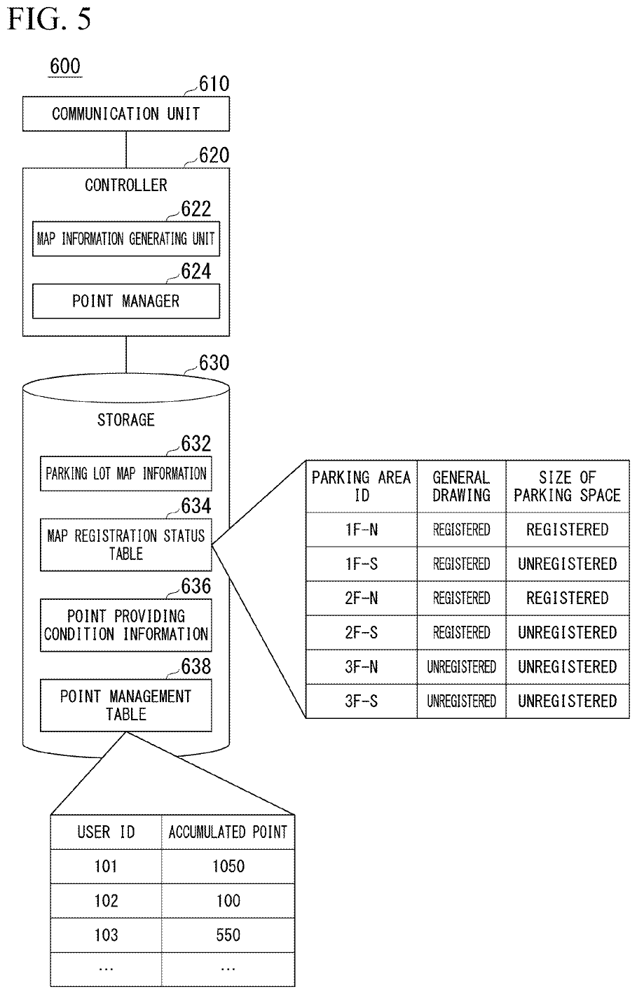

FIG. 5 is a diagram illustrating an example of the configuration of the map server 600. The map server 600 includes, for example, a communication unit 610, a controller 620, and a storage 630. Information such as parking lot map information 632 and a map registration status table 634 is stored in the storage 630.

The communication unit 610 communicates with the host vehicle M or other vehicles wirelessly. The controller 620 includes, for example, a map information generating unit 622 and a point manager 624. The map information generating unit 622 generates map information of the parking lot on the basis of the surrounding environment information acquired by the communication unit 610 and updates a part of the parking lot map information 632. The map information generating unit 622 derives coordinates of parking spaces PS, size information of the parking spaces PS, or the like on the basis of the surrounding environment information and reflects the derived information in the map information. The parking lot map information 632 corresponds to the original of the parking lot map information 432.

The point manager 624 determines points which are provided to a user of the host vehicle M which has uploaded the surrounding environment information on the basis of the surrounding environment information acquired by the communication unit 610. The point manager 624 determines the points on the basis of an amount of information, an acquisition time, or information accuracy of the provided surrounding environment information, a traveling distance, a distance from an entrance or an exit, or the like with reference to point providing condition information 636. The information accuracy is evaluated, for example, on the basis of a degree of matching with information which is stored in advance or a resolution. In the point providing condition information 636, points to be provided are defined for each point providing condition. In the point providing condition information 636, for example, it is defined that the score increases as the amount of information of the surrounding environment information increases, the score increases as the acquisition time of the surrounding environment information becomes later, the score increases as the information accuracy becomes higher, the score increases as the traveling distance in the parking lot becomes longer, the score increases as the traveling place or the position of a parking space of which size information has been acquired becomes farther from the entrance or the exit, and the like.

The point manager 624 determines points on the basis of movement details of the host vehicle M for acquiring the surrounding environment information. For example, the point manager 624 determines the points on the basis of surrounding environment information obtained by excluding the surrounding environment information acquired through traveling for parking the host vehicle M in the first parking space PS1 which is a target or the parking from the surrounding environment information acquired in a period after the host vehicle M has entered the parking lot and before the host vehicle M has exited the parking lot. In this way, the point manager 624 determines a target for which points are to be provided. The target for which points are to be provided may be determined on the basis of the route on which the host vehicle M has traveled or the position of the parking space PS in which the host vehicle M is parked or may be determined on the basis of the acquired surrounding environment information. The point manager 624 may determine the target for which points are to be provided on the basis of a ratio of unregistered areas to the entire parking lot PA. For example, when the ratio of unregistered areas is 50%, the point manager 624 provides 50% of the points which are determined on the basis of the traveling distance that the host vehicle has traveled in the parking lot PA.

The point manager 624 may determine the points according to an intention which is presented by a user. An intention which is presented by a user includes, for example, an intention of agreeing to use of the host vehicle M to acquire surrounding environment information in a valet parking period. When the intention of agreeing thereto is presented, the point manager 624 sets the points which are provided to a user to be higher than in a case in which the intention of agreeing thereto is not presented.

The point manager 624 provides the determined points to the user by storing the determined points in a point management table 638 in correlation with a user ID which is identification information of the user of the host vehicle M. In the point management table 638, for example, accumulated points are correlated with user IDs. The accumulated points are an accumulated value of effective points. The invention is not limited thereto, and the point management table 638 may be a table for managing points every time, a date and time at which the points are provided, and the like for each user ID.

In the map registration status table 634, for example, information indicating whether registration in the parking lot map information 632 has been completed (registered) or whether registration has not been completed (unregistered) is correlated with a parking area ID which is identification information of a parking area. Details of the registration status in the parking lot map information 632 can be arbitrarily set and, for example, it is assumed that map information geometrically indicating a structure of a parking lot PA is prepared on the basis of size information of all parking spaces PS. The invention is not limited thereto, and when map information which geometrically represents the structure of the parking lot PA is prepared without using size information of the parking spaces PS, it may be determined that registration has been completed. The parking area ID may be assigned to each parking area or may be assigned to each section when the parking lot is divided into a plurality of sections. In the map registration status table 634, for example, a registration status of a general drawing of the parking lot PA (a general drawing of each section), a registration status of size information of each parking space PS, or the like may be managed.

When the communication unit 610 receives surrounding environment information from a vehicle, the map information generating unit 622 generates map information of the parking lot on the basis of the received surrounding environment information and adds the generated map information to the parking lot map information 632. When the map information is added to the parking lot map information 632, the map information generating unit 622 updates the map registration status table 634. The map information generating unit 622 may transmit the map information to the parking lot management device 400, for example, at the time at which the parking lot map information 632 is updated. In this case, the parking lot management device 400 can update the parking lot map information 432 on the basis of the map information of the parking lot which is generated on the basis of the surrounding environment information received from vehicles.

Automatic Parking Event—Acquisition of Surrounding Environment Information

When a predetermined condition such as a condition that the parking lot PA at which the host vehicle M is parked is a parking lot of which map information has not been registered in the map server 600 has been satisfied, the automatic parking controller 142 causes the host vehicle M to travel automatically or the like (including parking) to acquire surrounding environment information. Causing the host vehicle M to travel automatically to acquire surrounding environment information is hereinafter referred to as “performing information acquisition movement.”

“Performing information acquisition movement” includes causing the host vehicle M to travel in an unregistered area which has not already been registered in the parking lot map information 432 in the parking lot PA and causing the host vehicle M to park in an unregistered area. An unregistered area includes each floor, a part of each floor, and a parking space PS. The automatic parking controller 142 moves in an unregistered area while sensing the surroundings by itself. The invention is not limited thereto and the automatic parking controller 142 may be guided to a parking space PS which is an unregistered area on the basis of information acquired from the parking lot management device 400 by the communication device 20.

The time at which “information acquisition movement is performed” may be set to a time before the host vehicle M has been parked in a first parking space PS1 or a time before the host vehicle M has been parked in the first parking space PS1. In the former, traveling or the like after the host vehicle M has been parked in the first parking space PS1 is movement for acquiring surrounding environment information, and a target for which points are to be provided which will be described later (movement after the host vehicle M has been parked in the first parking space PS1 is the target) becomes clear. In the latter, since surrounding environment information can be acquired while the host vehicle M is moving to the first parking space PS1, it is possible to efficiently acquire surrounding environment information.

“Performing information acquisition movement” may include, for example, causing the host vehicle M to travel on a route (hereinafter referred to as a second route) which departs from an optimal route for parking a vehicle in the first parking space PS1 which is a destination (hereinafter referred to as a first route) and which extends to an unregistered area. The optimal route includes, for example, a route with a shortest traveling distance to a destination and a route with a shortest traveling time to a destination.

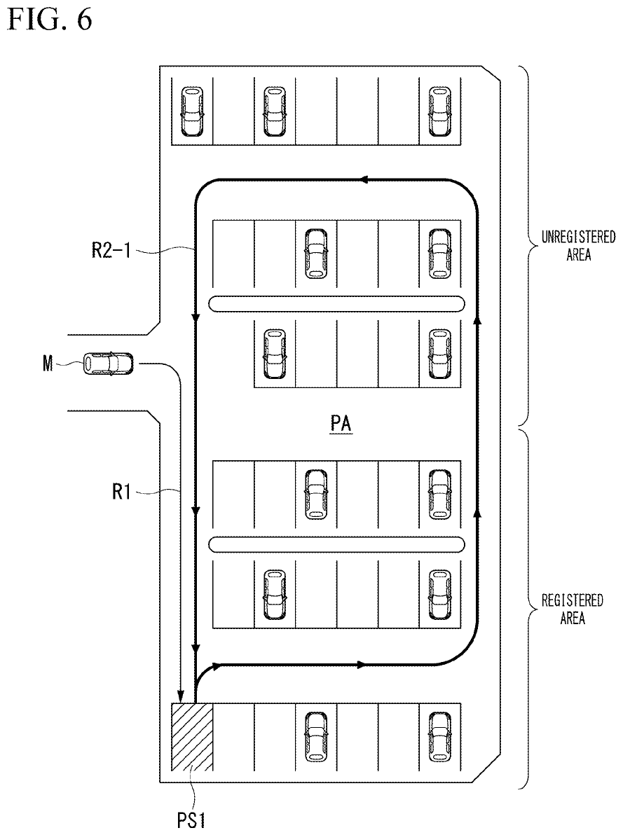

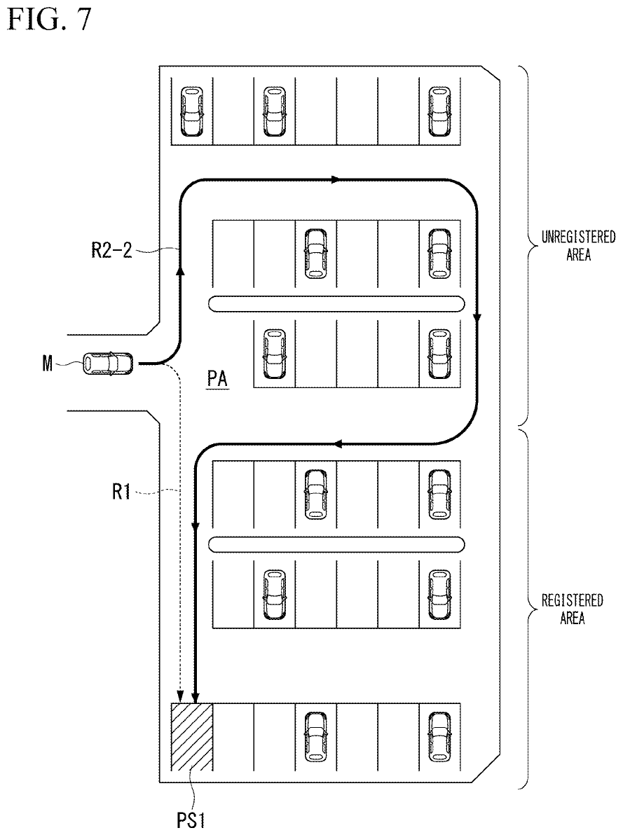

FIGS. 6 and 7 are diagrams illustrating a second route. In FIGS. 6 and 7, a lower part of the parking lot PA is a registered area and an upper part of the parking lot PA is an unregistered area. In the example illustrated in FIG. 6, the host vehicle M travels on a first route R1, parks in a first parking space PS1, and then travels on a second route R2-1 including an unregistered area. In the example illustrated in FIG. 7, the host vehicle M does not travel on the first route R1, but travels on a second route R2-2 including an unregistered area before parking in the first parking space PS1 and parks in the first parking space PS1.

“Performing information acquisition movement” may include causing the host vehicle M to park in a parking space PS which is different from the first parking space PS1 and which is an unregistered area (hereinafter referred to as a second parking space PS2).

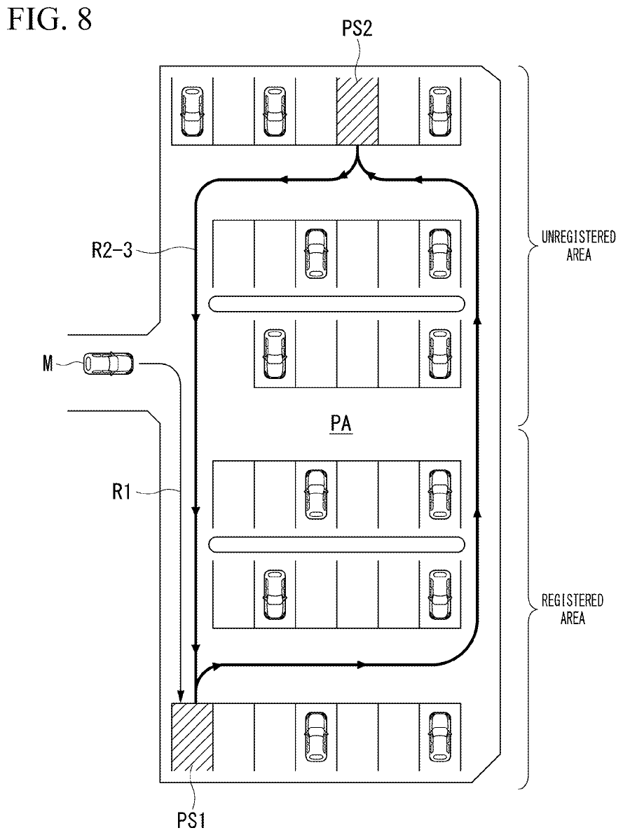

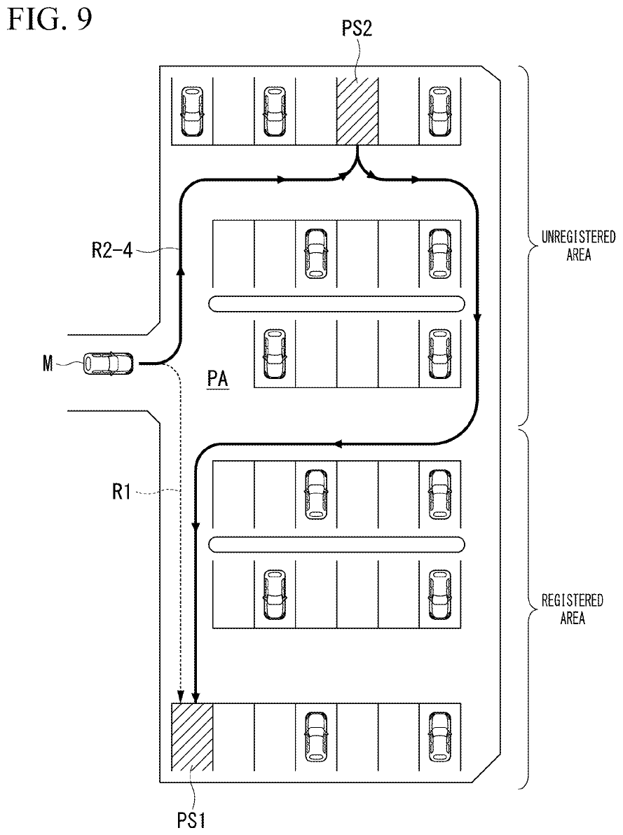

FIGS. 8 and 9 are diagrams illustrating an example of a second parking space. In FIGS. 8 and 9, a lower part of the parking lot PA is a registered area and an upper part of the parking lot PA is an unregistered area. In the example illustrated in FIG. 8, the host vehicle M travels on a first route R1, parks in a first parking space PS1, and travels on a second route R2-3 along which the host vehicle M temporarily parks in a second parking space PS2 and then returns to the first parking space PS1. In the example illustrated in FIG. 9, the host vehicle M does not travel on the first route R1, but travels on a second route R2-4 along which the host vehicle M temporarily parks in the second parking space PS2 and returns to the first parking space PS1 before parking in the first parking space PS1, and parks in the first parking space PS1.

The second route and the second parking space PS2 are not limited to the examples illustrated in the drawings. For example, the second route may be an optimal route for traveling in an unregistered area and the number of second parking spaces PS2 may be two or more.

In FIGS. 6 to 9, the point manager 624 may determine traveling in an unregistered area as a target for which points are to be provided, or may determine traveling on the second route or traveling to the second parking space PS2 out of traveling in a registered area as a target for which points are to be provided.

The second route, the second parking space PS2, or the like may be determined by the automatic parking controller 142 or may be determined by the parking lot management device 400. In the former, the host vehicle M moves while sensing the surroundings by itself. In the latter, the host vehicle M moves according to guidance of the parking lot management device 400. The invention is not limited thereto, and the host vehicle M may move on the second route or the second parking space PS2 which is determined by the parking lot management device 400 while sensing the surroundings by itself.

The second route or the second parking space PS2 may be determined not to interfere with another vehicle on the basis of a parking position or a parking route of the other vehicle in the parking lot PA. Preventing interference with another vehicle includes, for example, traveling in a direction which is different from a route for the other vehicle or parking in a parking space which is different from a parking space PS in which the other vehicle is parked.

When a predetermined condition is satisfied, the automatic parking controller 142 causes the host vehicle M to travel autonomously or the like to acquire surrounding environment information. The predetermined condition includes, for example, some or all of a condition that registration in the parking lot map information 632 of the map server 600 has not been completed, a condition that uploading of surrounding environment information is permitted by a user of the host vehicle M, and a condition that the parking lot (the predetermined space) is not congested. When the predetermined condition includes a plurality of conditions, the automatic parking controller 142 may determine that the predetermined condition has been satisfied when all of the plurality of conditions have been satisfied or may determine that the predetermined condition has been satisfied when some conditions have been satisfied. For example, when the congestion situation determiner 146 determines that the parking a lot PA is not congested, the automatic parking controller 142 determines that the parking a lot is not congested.

When a predetermined restrictive condition is set, the automatic parking controller 142 performs driving control for causing the host vehicle M to travel autonomously to acquire surrounding environment information within a restricted range. The driving control includes at least one of causing a vehicle to perform a traveling operation and causing a vehicle to perform a parking operation. Examples of the predetermined restrictive condition include a traveling distance that the host vehicle M travels to acquire surrounding environment information and the number of times the host vehicle M parks in a parking space PS to acquire surrounding environment information. The predetermined restrictive condition may be restricted by a user of the host vehicle M or may be restricted by a user who manages surrounding environment information.

The “predetermined restrictive condition” may be, for example, a condition that an amount of residual energy of the host vehicle M is maintained equal to or greater than a predetermined value. In this case, the automatic parking controller 142 derives a travelable distance on the basis of the amount of residual energy of the host vehicle M, selects the shorter of the derived travelable distance and a traveling distance which is restricted by the user of the host vehicle M, and performs driving control for causing the host vehicle M to travel within a range of the selected distance.

Operation Flow

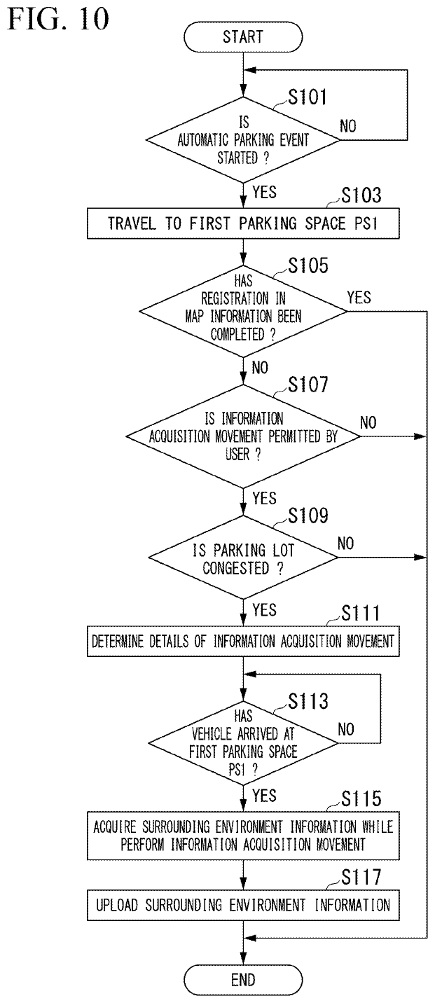

FIG. 10 is a flowchart illustrating an example of a process flow which is performed by the automatic parking controller 142 and the surrounding environment information acquirer 144. An example in which the time at which “information acquisition movement is performed” is set to a time after the host vehicle M has been parked in a first parking space PS1 will be now described.

For example, when valet parking is instructed by an occupant, the automatic parking controller 142 starts an automatic parking event (Step S101), and causes the host vehicle M to travel to the first parking space PS1 (Step S103). Subsequently, the automatic parking controller 142 determines details of information acquisition movement (Step S111) when registration in map information has not been completed (Step S105), the information acquisition movement is permitted by a user (Step S107), and the parking lot is not congested (Step S109). On the other hand, when registration in the map information has been completed in Step S105, when the information acquisition movement is not permitted by the user in Step S107, or when the parking lot is congested in step S109, the automatic parking controller 142 determines that the information acquisition movement is not to be performed and ends the process flow. Determining of details of the information acquisition movement includes determining of a traveling distance or a traveling route for traveling in an unregistered area or the like.

Subsequently, when the host vehicle M arrives at the first parking space PS1 (Step S113), the automatic parking controller 142 performs automated driving for causing the host vehicle to travel or the like in accordance with the determined details of the information acquisition movement and the surrounding environment information acquirer 144 acquires surrounding environment information at the same time (Step S115). Then, the surrounding environment information acquirer 144 uploads the acquired surrounding environment information to the map server 600 (Step S117).

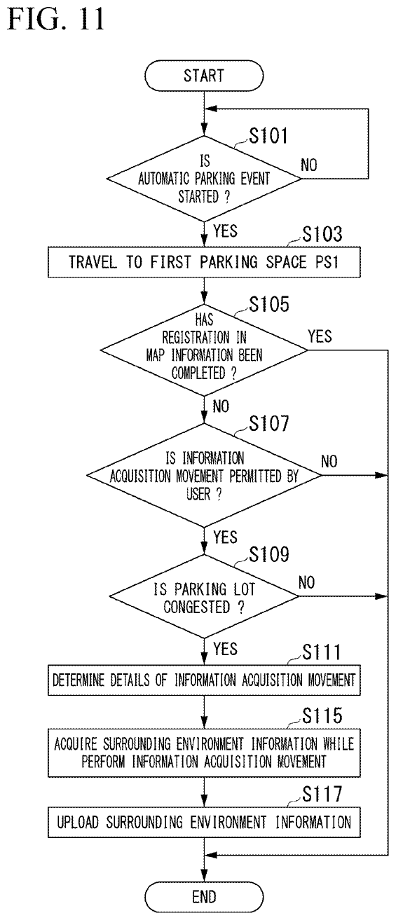

When the time at which “information acquisition movement is performed” is a time before the host vehicle M is parked in the first parking space PS1, the process of Step S113 in FIG. 10 is not necessary and, for example, a process flow illustrated in FIG. 11 is performed. Details of the steps are the same as the above-mentioned details and detailed description thereof will not be repeated.

### Conclusion of Embodiment

As described above, the automated driving control device 100 according to this embodiment includes a recognizer 130 that recognizes a surrounding environment of a vehicle, a driving controller (a movement plan creator 140 and a second controller 160) that performs driving control including at least one of speed control and steering control of the vehicle on the basis of a result of recognition from the recognizer 130, and a surrounding environment information acquirer 144 that acquires surrounding environment information of the surrounding environment of the vehicle in a predetermined space on the basis of the result of recognition from the recognizer 130 in a period after the vehicle enters the predetermined space and before the vehicle exits the predetermined space under the driving control of the driving controller and uploads the acquired surrounding environment information to a map server 600 (or a parking lot management device 400). Accordingly, it is possible to acquire map information in a parking lot for which map information has not been known. Accordingly, it is possible to contribute to expansion of parking lots to which a valet parking system for moving a vehicle automatically can be applied.

Hardware Configuration

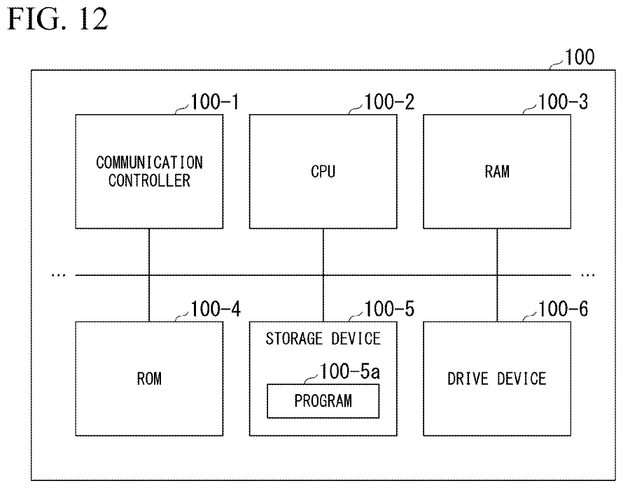

FIG. 12 is a diagram illustrating an example of a hardware configuration of the automated driving control device 100 according to the embodiment. As illustrated in the drawing, the automated driving control device 100 has a configuration in which a communication controller 100-1, a CPU 100-2, a random access memory (RAM) 100-3 which is used as a work memory, a read only memory (ROM) 100-4 that stores a booting program or the like, a storage device 100-5 such as a flash memory or a hard disk drive (HDD), a drive device 100-6, and the like are connected to each other via an internal bus or a dedicated communication line. The communication controller 100-1 communicates with elements other than the automated driving control device 100. A program 100-5a which is executed by the CPU 100-2 is stored in the storage device 100-5. This program is loaded into the RAM 100-3 by a direct memory access (DMA) controller (not illustrated) or the like and is executed by the CPU 100-2. Accordingly, one or both of the first controller 120 and the second controller 160 are embodied.

The above-mentioned embodiment can be expressed as follows:

A vehicle control device including:

a storage device that stores a program; and

a hardware processor,

wherein the hardware processor is configured to perform, by executing the program stored in the storage device, recognizing a surrounding environment of a vehicle, performing driving control including at least one of speed control and steering control of the vehicle on the basis of a result of recognition, acquiring surrounding environment information of the surrounding environment of the vehicle in a predetermined space on the basis of the result of recognition in a period after the vehicle enters the predetermined space and before the vehicle exits the predetermined space under the driving control of the driving controller, and uploading the acquired surrounding environment information to an external device.

While the invention has been described with reference to an embodiment, the invention is not limited to the embodiment and can be subjected to various modifications and substitutions without departing from the gist of the invention.

For example, the first parking space PS1 which is a destination is not limited to a closest parking space PS. For example, when the first parking space PS1 may be a parking space PS (empty) which is the closest to a final point of a route for information acquisition movement after the route for the information acquisition movement has been determined.

Whether the host vehicle M is to perform information acquisition movement may be determined by the automatic parking controller 142 at a time point at which the host vehicle M enters a site of a parking lot PA.

The parking lot management device 400 may include a functional configuration or information of the map server 600.

Whether the host vehicle M is to perform information acquisition movement may be determined by the map server 600 or the parking lot management device 400.

Details of the information acquisition movement of the host vehicle may be determined by the map server 600 or the parking lot management device 400.

Some functions of the automatic parking controller 142 or the surrounding environment information acquirer 144 may be realized by the map server 600 or the parking lot management device 400.

What is claimed is:

1. A vehicle control device comprising:
a recognizer configured to recognize a surrounding environment of a vehicle;
a driving controller configured to perform driving control including at least one of speed control and steering control of the vehicle on the basis of a result of recognition from the recognizer; and
an information acquirer configured to acquire surrounding environment information of the surrounding environment of the vehicle in a predetermined space on the basis of the result of recognition from the recognizer in a period after the vehicle enters the predetermined space and before the vehicle exits the predetermined space under the driving control of the driving controller, and to upload the acquired surrounding environment information to an external device.

2. The vehicle control device according to claim 1,
wherein the information acquirer is configured to acquire the surrounding environment information when the driving controller performs the driving control in the period.

3. The vehicle control device according to claim 1,
wherein the driving controller is configured to perform the driving control for acquiring the surrounding environment information when a predetermined condition has been satisfied.

4. The vehicle control device according to claim 3,
wherein the predetermined condition includes a condition that the predetermined space is a parking lot in which map information has not been registered in the external device.

5. The vehicle control device according to claim 3,
wherein the predetermined condition includes a condition that uploading of the surrounding environment information is permitted by a user of the vehicle.

6. The vehicle control device according to claim 3,
wherein the driving controller is configured to perform driving control for acquiring the surrounding environment information in a limited range when a travel distance that the vehicle travels to acquire the surrounding environment information is limited by a user of the vehicle.

7. The vehicle control device according to claim 3,
wherein the driving controller is configured to perform driving control for acquiring the surrounding environment information in a limited range when the number of times the vehicle is parked to acquire the surrounding environment information is limited by a user of the vehicle.

8. The vehicle control device according to claim 3,
wherein the driving controller is configured to derive a travelable distance on the basis of an amount of residual energy of the vehicle, to select the shorter of the derived travelable distance and a travel distance which is limited by a user of the vehicle, and to perform driving control for acquiring the surrounding environment information in a range of the selected distance.

9. The vehicle control device according to claim 3,
further comprising a congestion situation determiner configured to determine whether the predetermined space is congested,
wherein the predetermined condition includes a condition that the congestion situation determiner determines that the predetermined space is not congested.

10. The vehicle control device according to claim 1,
wherein the predetermined space is a parking lot, and
wherein the period is a period after the vehicle enters the parking lot and before the vehicle exits the parking lot.

11. The vehicle control device according to claim 1,
wherein the information acquirer is configured to acquire the surrounding environment information on the basis of the result of recognition from the recognizer when the vehicle is traveling without a driver in the predetermined space.

12. A vehicle control system comprising:
the vehicle control device according to claim 1; and
the external device including a point manager configured to determine points which are provided to a user of the vehicle having uploaded the surrounding environment information on the basis of the surrounding environment information acquired by the information acquirer,
wherein the point manager is configured to determine the points on the basis of the surrounding environment information which is obtained by excluding information acquired in travel for parking at a closest parking space or the parking from information acquired in a period after the vehicle has entered the predetermined space and before the vehicle has exited the predetermined space.

13. The vehicle control system according to claim 12,
wherein the point manager is configured to determine the points which vary depending on an amount of information of the surrounding environment information or a time point at which the surrounding environment information has been acquired.

14. The vehicle control system according to claim 12,
wherein the point manager is configured to set the points which are provided to the user of the vehicle to be higher when the user presents an intention to agree to travel of the vehicle to acquire the surrounding environment information than when the user does not present the intention to agree.

15. A vehicle control method of causing a computer mounted in a vehicle to perform:
recognizing a surrounding environment of the vehicle;
performing driving control including at least one of speed control and steering control of the vehicle on the basis of a result of recognition;
acquiring surrounding environment information of the surrounding environment of the vehicle in a predetermined space on the basis of the result of recognition from the recognizer in a period after the vehicle enters the predetermined space and before the vehicle exits the predetermined space under the driving control; and
uploading the acquired surrounding environment information to an external device.

16. A non-transitory computer-readable storage medium that stores a program causing a computer mounted in a vehicle to perform:
recognizing a surrounding environment of the vehicle;
performing driving control including at least one of speed control and steering control of the vehicle on the basis of a result of recognition;
acquiring surrounding environment information of the surrounding environment of the vehicle in a predetermined space on the basis of the result of recognition from the recognizer in a period after the vehicle enters the predetermined space and before the vehicle exits the predetermined space under the driving control; and
uploading the acquired surrounding environment information to an external device.
